(19) United States
(12) Patent Application Publication
(10) Pub. No.: US 2023/0235565 A1
(43) Pub. Date: Jul. 27, 2023

(54) TRAVELING ASSISTANCE TOOL FOR WHEELCHAIR

(71) Applicants: SUMITOMO RUBBER INDUSTRIES, LTD., Kobe-shi, Hyogo (JP); Toray Industries, Inc., Tokyo (JP)

(72) Inventors: Masayuki Matsushita, Kobe-shi, Hyogo (JP); Junichiro Hoshikawa, Kobe-shi, Hyogo (JP); Hiromi Taniguchi, Nagoya-shi, Aichi (JP); Nobuo Asahara, Nagoya-shi, Aichi (JP); Yohei Noguchi, Nagoya-shi, Aichi (JP); Akira Tanaka, Nagoya-shi, Aichi (JP)

(21) Appl. No.: 18/010,837

(22) PCT Filed: Jun. 11, 2021
(86) PCT No.: PCT/JP2021/022379

§ 371 Date: Dec. 16, 2022

(30) Foreign Application Priority Data
Jun. 24, 2020 (JP) 2020-108883

(51) Int. Cl. E04F 11/00; A61G 5/06

(52) U.S. Cl. CPC E04F 11/002; A61G 5/06

(57) ABSTRACT

This traveling assistance tool for a wheelchair includes a travel path member including a travel path part on which a wheelchair travels and a reinforcing part for reinforcing the travel path part from below; and end members which are fitted to the ends of the travel path member to introduce a wheelchair onto the travel path part, the reinforcing part being constituted of a plurality of hollow segments arranged in a single line in the crossing direction of the travel path part, where the traveling assistance tool for a wheelchair is characterized in that the end members have: insertion parts which are inserted into ends of the reinforcing parts; and a support part which supports the ends of the reinforcing part from below.

### TECHNICAL FIELD

This disclosure relates to a traveling assistance tool used with a ramp to be placed over a step between objects, the ramp being excellent in lightness, load bearing capacity and durability, and specifically relates to a traveling assistance tool used with a portable ramp capable of making a wheelchair user board/exit a train in safety.

### BACKGROUND

Elevators and escalators are installed as barrier-free measures in public facilities while stairs are provided with ramps for bypass routes so that wheelchairs can travel easily. However, many steps still exist inside and outside buildings such as public facilities. Such a step may be difficult for wheelchair users and elderly people to get over although healthy people can do it easily.

Regardless of advanced barrier-free society infrastructure, many uncontrolled steps exist so that it may be difficult for wheelchairs to get over barriers such as steps between sidewalk/bus doorway and road, grooves on road, grooves or steps between train doorway and platform or the like.

Such many steps exist even inside and outside personal houses of wheelchair users or elderly people, in addition to public spaces such as transportation means.

There is a recently developed portable ramp which can be set as needed when a wheelchair travels from a platform into a train or from a train doorway onto a platform or when a wheelchair travels from a road into a bus or from a bus doorway onto a road. A plank is placed to make a ramp over the step between the platform/road and the train/bus to support the wheelchair.

Because these ramps are preferably light enough to be carried about easily, they are usually made of resin or fiber-reinforced plastics excellent in lightness and load bearing capacity, rather than metal or wood, as disclosed in JP 2011-217963 A and JP 2013-162818 A.

Because the ramp for wheelchairs such as electric wheelchair is a plank tool on which a wheelchair taking on a care-receiver travels by support of caregivers, the ramp should not be steeply placed over the step. If there is a great difference of height between objects, the ramp should be long to the extent allowed by strength/rigidity for safety and lightness for easy handling.

JP '963 discloses a ramp for an electric train used between a doorway of a train and a platform comprising: a plate-like ramp body having a length in which one end side is placed on the doorway and the other end side is placed on the platform, and has a width allowing the wheelchair to pass therethrough; a hook member having a hanging piece which is fixed to an edge part on one end side of the ramp body and is capable of being engaged with a step part provided in the entrance and exit by bending downward at a tip part of a base piece extending in a direction away from the ramp body; and a flap which is connected to the hook member to be swingable about an axis along the width direction of the ramp body and which extends in a direction away from the base piece, wherein the ramp body is made of fiber-reinforced resin so that the wheelchair user can travel easily between the platform and the train on the ramp.

However, JP '963 fails to disclose reinforcing structure of ramp supporting end while disclosing only that the ramp body is made of fiber-reinforced resin.

JP '818 discloses a portable ramp including at least two pieces of plywood for which plate materials made of fiber reinforced plastic (FRP) are bonded to both front and back surfaces of a square core material composed of a foamable resin, wherein the pieces of plywood have tapered structures 4 and 5 for dissolving the level difference of the pieces of plywood themselves at respective upper and lower ends in a passing direction and have a structure for which an outer side face to the passing direction is fitted by a frame member 9, two or more pieces of plywood are arranged side by side with respect to the passing direction, opposed side faces of the pieces of plywood are connected by a sheet material 6, and the pieces of plywood are made foldable so that a portable ramp which is light in weight and easy to carry can be easily manufactured at a low cost in an optimum size with excellent workability, is excellent in a fixing performance, is not easily broken by a high impact resistant performance of a ramp edge part and a derailment preventing wall, and has an excellent repair performance. The ramp of plywood is made by bonding carbon fiber-reinforced plastic to the top and bottom faces of core material made of foamable resin such as rigid urethane, polypropylene and acrylic.

However, the plywood disclosed in JP '818 has a laminate structure of foamable resin of which top and bottom faces are firmly bonded to carbon fiber-reinforced plastic so that production cost is expensive because of many processes in manufacturing the laminate structure. Further, although the laminate structure capable of improving rigidity can be formed with the foamable body over the ramp terminal, sufficient productivity and lightweight advantage cannot be achieved because of weight of the foamable body.

JP 2003-230600 A discloses a portable ramp used to be stretched across the stepped part between matters and comprising a plurality of plate materials comprising a fiber reinforced plastic, the derailment preventing wall having predetermined height (h) and thickness (t) is arranged on the upper surfaces of the plate material ends positioned on both left and right sides of the portable ramp, wherein the surface pressure resistance (f) is controlled within a predetermined range so that the derailment preventing wall can be made hard to be broken even if wheels ride on the derailment preventing wall while the portable ramp is lightweight and capable of being easily carried. JP '600 discloses a preferable configuration in which reinforcing fibers wound on a surface of core material made of hard foam polyurethane or the like and set to a mold into which matrix agent is poured to integrally form a plate member and the derailment preventing wall.

Although the structure disclosed in JP '600 can improve rigidity by employing laminate structure, it cannot have lightweight advantage because of weight of the foamable body.

JP 2014-103983 A discloses a portable ramp comprises a tabular ramp body whose top face is a face on which a wheel chair travels, wherein the ramp body comprises a tabular core composed of corrugated cardboard material, and a reinforcement layer composed of fiber-reinforced resin material stuck to at least the top face and bottom face of the tabular core to further reduce weight and reduce the burden on the user, compared to when polyurethane foam is used as a plate-like core, while securing the necessary rigidity.

However, the reinforcement layer structure disclosed in JP '983 composed of fiber-reinforced resin material stuck to at least the top face and bottom face of the tabular core has to be manufactured in many processes of laminate structure production by spending expensive production cost.

JP 2002-87164 A discloses a ramp device capable of access a wheelchair or the like, wherein the floor member forming the ramp is divided into a plurality of parts in the direction crossing the direction of expansion of the ramp while engaged parts engageable with each other are integrally formed with the end faces of the floor member opposed to each other so that adjacent floor members being vertically engaged to receive a load on a ramp can perform operation at the time of deployment and storage of a ramp without lowering rigidity of the floor member while it is not necessary to reinforce the floor member by additional members.

However, in JP '164, the derailment preventing walls provided at both sides and fixed to floor members on the ramp by weld or screws are manufactured in many processes by spending expensive production cost. Further, it is necessary to use a plurality of ramps having lengths corresponding to different travelling distances while any reinforcing structure of supporting end is not disclosed.

JP-U-3172583 discloses an ultra-lightweight portable ramp 100 provided with a main body side part 91 integrally molded with a derailment preventing bar 43 on both side faces and a central side face part 90 on which a hinge 42 is screwed by shortening a train side. The surface part 80 is broken and made in the two central-site surface parts 91 installed in the central part side by side, is symmetrical, is provided as a flat floor line considered as the inclined plane which passes a large-sized wheelchair, and integral forming, keeps an even-sheet interval and provides the board which supports a reverse part vertically to a reverse part as a reinforcement section. A nylon band 44 is fixedly provided at a 2 folding point at the side of the platform side of a central side part 90 of a body and a side part 91 at a center side, and a hooking metal 40 hooked on a door rail on a train side is fixed to the train side of the surface part 80. A large number of through holes are formed in a main body side part 90, a surface part 80, and a super-duralumin AL 2024 used for a flat floor surface fixed to a reinforcing part. According to such configuration, rigidity of the ramp can be improved by hollow segments.

However, JP '583 fails to disclose improvement of weight saving since integral molding is performed with duralumin material heavier than CFRP by welding. Further, since the main body is provided with wind through holes which might deteriorate material rigidity, it would be difficult to achieve both long product length and weight saving.

JP 2007-118758 A discloses a ramp end structure in which hook-shaped members 5a, 5b, 5c and 5d are provided at respective ends of plate-shaped members 2a, 2b, 2c and 2d in a direction (direction of arrow 12 in FIG. 1; hereinafter referred to as “flow direction”) perpendicular to the connecting direction (direction of arrow 11 in FIG. 1), wherein rubber caps 7a, 7b, 7c and 7d as antiskid members are attached to the other ends of plate-shaped members 2a, 2b, 2c and 2d.

However, JP '758 fails to disclose reinforcing structure of end of the ramp although disclosing different type of joint structure.

JP 2016-067517 A discloses a ramp end structure in which symbol 1 indicates a portable ramp, symbol 2 indicates a plate member constituting a ramp portion on which wheelchairs or the like travel. For example, portable ramp 1 is used by being placed between a train doorway and a platform, the upper end 3 of ramp 1 being placed on the train doorway while the lower end 4 of ramp 1 being placed on the platform. JP '517 discloses preferable configuration such that: upper end 3 and lower end side 4 of ramp 1 are tapered to have a predetermined inclination to facilitate getting on and off of the wheelchair; a non-slip rubber member is fixed to the contact position to ramp 1 and/or the platform; and upper and lower ends 3 and 4 of ramp 1 are made of plastics being lightweight and inexpensive.

However, JP '517 fails to disclose insertion structure of the ramp end and suggestion of improving strength of the end.

JP-D-1527546 discloses a portable ramp to be placed over a step between objects in a building or a train, wherein a reinforcing section is provided on the bottom surface of the ramp in the longitudinal direction, the ramp being excellent in load bearing capacity and rigidity while it is lightweight with excellent portability. A wheelchair user can convey a ramp top at safety by installing a derailment protective barrier in the both side surfaces of a ramp. Since it comes to connect the ramp of two sheets, this article is foldable, and it can be developed and used at the time of use. The longitudinal direction both ends of the ramp are formed in tapered shape, respectively so that it may have a fixed inclination to make getting on and off of a wheelchair easy. According to such configuration, portability of the ramp can be improved.

However, JP '546 fails to disclose insertion structure of the ramp end and suggestion to improve strength of the end.

JP 2016-067518 A discloses a joint structure with hollow part of portable ramp in which a connecting part can be inserted into the hollow part.

However, JP '518 fails to disclose a supporting part and a concrete joint structure for relaxing stress concentration although disclosing the ramp insertion part.

It could therefore be helpful to provide a traveling assistance tool used with a ramp to be placed over a step between objects, which is light and has excellent portability, load bearing capacity and durability so that excellent safety is provided while ensuring rigidity when load is applied on the ramp when used by a wheelchair user, capable of corresponding to higher steps by being lengthened.

### SUMMARY

We thus provide:

(1) A traveling assistance tool for a wheelchair comprises:

a travel path member including a travel path part on which the wheelchair travels and a reinforcing part which reinforces the travel path part from below; and

an end member which is fitted to an end of the travel path member to introduce the wheelchair onto the travel path part,

the reinforcing part being formed by a plurality of hollow segments disposed along a bridging direction of the travel path part,

the end member having an insertion part to be inserted into an end of the reinforcing part and a support part to support the end of the reinforcing part from below.

We improve the strength of a hollow ramp used by a wheelchair user to get over steps in a building or steps between the ground and the doorway of vehicles such as automobile, train and bus by relaxing stress concentration caused in the support end of rigid hollow ramp against bending in the bridging direction. Such a reinforced support end can achieve both weight saving up to 12 kg of ramp weight and long ramp length up to 3 m so that safety is ensured and burden is reduced for caregivers. For example, our lightweight ramp can be placed for wheelchairs to travel on by inclination angle of 14° or less over the height difference of 70 cm over which conventional short lightweight ramp cannot make wheelchairs get over because of steepness.

(2) The traveling assistance tool according to (1), wherein the insertion part and the support part are disposed alternately on the end member. The insertion part and the support part provided alternately can make it hard for a resin component part at the ramp end to fall off.
(3) The traveling assistance tool according to (1) or (2), wherein the insertion part and the support part have an extruded shape.
(4) The traveling assistance tool according to any one of (1) to (3), wherein the reinforcing member is positioned by an external component part provided at an end of the hollow segment.
(5) The traveling assistance tool according to any one of (1) to (4), wherein the insertion part has a length of 1 or more and 2 or less of that of the support member. The insertion part and the support part having different insertion lengths can relax a stress concentration.
(6) The traveling assistance tool according to any one of (1) to (5), wherein the travel path member is made of a carbon fiber-reinforced plastic and the end member is made of a resin. A rigid and inexpensive ramp can be formed by pultruding the hollow segment from carbon fiber-reinforced resin.

We provide a traveling assistance tool used with a ramp to be placed over a step between objects in a building or a train, which is light and has excellent portability, load bearing capacity and durability so that excellent safety is provided while ensuring rigidity when load is applied on the ramp when used by a wheelchair user, capable of corresponding to higher steps by being lengthened.

### BRIEF DESCRIPTION OF THE DRAWINGS

FIG. 1 is a perspective view of an example of a ramp viewed obliquely from above.

FIG. 2 is a perspective view of an example of a ramp viewed obliquely from below.

FIG. 3 is a perspective view of a joint between an example of a ramp and terminal member.

FIG. 4 is a cross section view of a joint between an example of a ramp and end member.

FIG. 5 is an assembly view of an example of a ramp and a rod member of end member.

### EXPLANATION OF SYMBOLS

1: ramp
2: travel path member
3: upper end of ramp
4: lower end of ramp
5: hollow segment
6,6a,6b,6c: hollow part of hollow segment
7,7a,7b,7c: insertion part
8,8a,8b: support part
9: reinforcing member

### DETAILED DESCRIPTION

Hereinafter, our tools will be explained sequentially. Our tools are not limited to the following examples which are only representative.

Our traveling assistance tool for a wheelchair comprises: a travel path member including a travel path part on which the wheelchair travels and a reinforcing part which reinforces the travel path part from below; and an end member which is fitted to an end of the travel path member to introduce the wheelchair onto the travel path part, the reinforcing part being formed by a plurality of hollow segments disposed along a bridging direction of the travel path part, the end member having an insertion part to be inserted into an end of the reinforcing part and a support part to support the end of the reinforcing part from below.

We improve the strength of a hollow ramp used by a wheelchair user to get over steps in a building or steps between the ground and the doorway of vehicles such as automobile, train and bus by relaxing stress concentration caused in the support end of rigid hollow ramp against bending in the bridging direction. Such a reinforced support end can achieve both weight saving up to 12 kg of ramp weight and long ramp length up to 3 m so that safety is ensured and burden is reduced for caregivers. For example, our lightweight ramp can be placed for wheelchairs to travel on by inclination angle of 14° or less over the height difference of 70 cm over which conventional short lightweight ramp cannot make wheelchairs get over because of steepness.

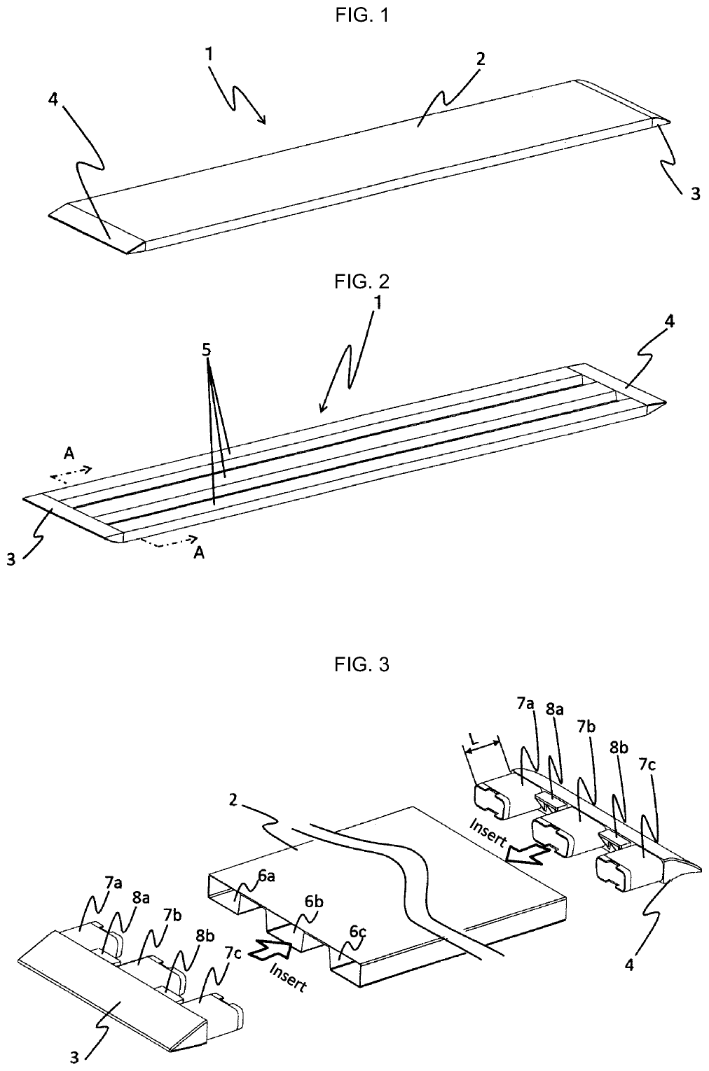

FIG. 1 shows a perspective view of our ramp viewed obliquely from above. Symbol 1 indicates ramp for wheelchairs to travel on while symbol 2 indicates travel path part. Ramp 1 can be used as being placed over the gap between road and automobile doorway. Upper end member 3 of ramp 1 is placed on the automobile doorway while lower end member 4 of ramp 1 is placed on the road, for example. It is possible that upper end member 3 and lower end member 4 of ramp 1 bonded to travel path member 2 are tapered so that wheelchairs smoothly travel through the inclined ends. It is preferable that an antiskid rubber member is attached to a position to contact the doorway or the road of ramp 1.

FIG. 2 shows a perspective view of our ramp viewed obliquely from below. Symbol 5 indicates hollow segment. Hollow segments 5 are provided as totally extending substantially along the longitudinal direction of travel path member 2 in which moving bodies such as wheelchair travel. Such a long product structure extending between end member 3 and end member 4 can bear local load applied from tires of wheelchair or the like traveling on ramp 1.

From a viewpoint of weight saving, it is preferable that travel path member 2 and hollow segment 5 is made of a carbon fiber-reinforced plastic excellent in specific strength and specific rigidity. The reinforcing fiber may be a carbon fiber of polyacrylonitrile (PAN)-based, rayon-based, lignin-based or pitch-based, with or without surface treatment. The surface treatment may be performed with coupling agent, sizing agent, binding agent or additives. The above-described reinforcing fibers can be used solely or mixed by two or more kinds.

The fiber-reinforced plastic comprises reinforcing fiber and matrix resin, wherein the matrix resin may be a thermosetting resin such as epoxy resin, unsaturated polyester resin, vinylester resin, phenol (resol type) resin and polyimide resin, a polyester resin such as polyethylene terephthalate (PET) resin, polybutylene terephthalate (PBT) resin, poly trimethylene terephthalate (PTT) resin, polyethylene naphthalate (PEN resin) and liquid crystalline polyester resin, a polyolefin resin such as polyethylene (PE resin), polypropylene (PP resin) and polybutylene resin, a polyoxymethylene (POM) resin, a polyamide (PA) resin, a polyarylene sulfide resin such as polyphenylene sulfide (PPS) resin, a polyketone (PK) resin, a polyether ketone (PEK) resin, a polyetheretherketone (PEEK) resin, a polyether ketone (PEKK) resin, a polyether nitrile (PEN) resin, a fluorinated resin such as polytetrafluoroethylene resin, a crystalline resin such as liquid crystal polymer (LCP), a styrenic resin, an amorphous resin such as polycarbonate (PC) resin, polymethylmethacrylate (PMMA) resin, polyvinyl chloride (PVC) resin, polyphenylene ether (PPE) resin, polyimide (PI) resin, polyamide-imide (PAI) resin, polyetherimide (PEI) resin, polysulfone (PSU) resin, polyethersulfone resin and polyarylate (PAR) resin, a thermoplastic elastomer of phenol-based, phenoxy-based, polystyrene-based, polyolefin-based, polyurethane-based, polyester-based, polyamide-based, polybutadiene-based, polyisoprene-based or acrylonitrile-based, or a copolymer or modification thereof. Above all, it is preferably the epoxy resin or the vinylester resin from viewpoints of adhesion to carbon fibers, mechanical properties of shaped product and formability.

It is preferable that the fiber-reinforced resin of carbon fiber has a weight fiber content of 15 to 80 wt %. The content of less than 15 wt % might have insufficient load bearing capacity and rigidity so that a predetermined target function is not achieved. The weight content of more than 80 wt % might have voids to make a forming process have problems. For long products requiring high elastic modulus and high strength, it is preferable that the weight content is controlled to a smaller range of 30 to 75 wt % or the like, preferably 40 to 75 wt %.

It is preferable that the fiber-reinforced plastic constituting travel path member 2 or hollow segment 5 comprises continuous carbon fibers. The reinforcing fibers may be disposed in parallel with the longitudinal direction of the bridging direction of the ramp or disposed substantially orthogonal to the longitudinal direction. These disposition patterns can be combined to improve bending strength and surface pressure resistance as a whole ramp.

The resin material constituting end members 3 and 4 are not limited in particular, and may be a thermosetting resin such as epoxy resin, unsaturated polyester resin, vinylester resin, phenol (resol type) resin and polyimide resin, a polyester resin such as polyethylene terephthalate (PET) resin, polybutylene terephthalate (PBT) resin, poly trimethylene terephthalate (PTT) resin, polyethylene naphthalate (PEN resin) and liquid crystalline polyester resin, a polyolefin resin such as polyethylene (PE resin), polypropylene (PP resin) and polybutylene resin, a polyoxymethylene (POM) resin, a polyamide (PA) resin, a polyarylene sulfide resin such as polyphenylene sulfide (PPS) resin, a polyketone (PK) resin, a polyether ketone (PEK) resin, a polyetheretherketone (PEEK) resin, a polyether ketone ketone (PEKK) resin, a polyether nitrile (PEN) resin, a fluorinated resin such as polytetrafluoroethylene resin, a crystalline resin such as liquid crystal polymer (LCP), a styrenic resin, an amorphous resin such as polycarbonate (PC) resin, polymethylmethacrylate (PMMA) resin, polyvinyl chloride (PVC) resin, polyphenylene ether (PPE) resin, polyimide (PI) resin, polyamide-imide (PAI) resin, polyetherimide (PEI) resin, polysulfone (PSU) resin, polyethersulfone resin and polyarylate (PAR) resin, a thermoplastic elastomer of phenol-based, phenoxy-based, polystyrene-based, polyolefin-based, polyurethane-based, polyester-based, polyamide-based, polybutadiene-based, polyisoprene-based or acrylonitrile-based, or a copolymer or modification thereof. Above all, it is preferable that the end member is made of a material structurally having a shear resistance so that buckling deformation and shear deformation of the ramp body are suppressed. From a viewpoint of weight saving, it is preferable that the end member is made of fiber-reinforced plastic. The reinforcing fiber is not limited in particular, and may be a metal fiber such as made of aluminum, brass and stainless steel, a carbon fiber of polyacrylonitrile (PAN)-based, rayon-based, lignin-based or pitch-based, a graphite fiber, an insulating fiber such as made of glass, an organic fiber such as made of aramid resin, polyphenylene sulfide resin, polyester resin, acrylic resin, nylon resin and polyethylene resin, or an inorganic fiber such as made of silicon carbide and silicon nitride, with or without surface treatment. The surface treatment may be performed with metallic conductor, coupling agent, sizing agent, binding agent or additives. The above-described reinforcing fibers can be used solely or mixed by two or more kinds. From a viewpoint of weight saving, it is preferable that the reinforcing fiber is made of carbon fiber of PAN-based, pitch-based or rayon-based, excellent in specific strength and specific rigidity. It is more preferable to employ the PAN-based carbon fiber excellent in mechanical characteristics such as strength and elastic modulus. It is possible that the reinforcing fiber is a discontinuous fiber or a continuous fiber. It is preferable that the reinforcing fiber is reinforced and oriented in two or more directions. It is preferable that the reinforcing member has an in-plane shear elastic modulus of 3,000 MPa or more.

FIG. 3 shows a perspective view of joint between ramp travel path part 2 and end members 3 and 4. In FIG. 3, symbols 6a, 6b and 6c indicate hollow part of the hollow segments into which insertion parts 7a, 7b and 7c are inserted to join travel path part 2 and end members 3 and 4. Symbols 8a and 8b of end members 3 and 4 indicate support parts which support travel path part 2 from below among insertion parts 7a, 7b and 7c.

If support insertion parts 7a, 7b and 7c of end members 3 and 4 are extended to the same position that support parts 8a and 8b are extended to, strength of ramp 1 might deteriorate by stress concentration caused at the interface integrating hollow segments 5 with travel path member 2 in the cross section of bent tip of insertion part 7 of end members 3 and 4 when ramp 1 is bent in the longitudinal direction. It is preferable that insertion part 7 and support part 8 have different extension lengths so that ramp strength is improved by preventing stress from concentrating in a certain bending cross section. Further, it is preferable that support part 8 has an extension length longer than that of insertion part 7 while it is preferable that insertion parts 7a, 7b and 7c have the same insertion length. When insertion parts 7a, 7b and 7c have different insertion length, ramp length might deteriorate by shear stress concentration caused at the contact part between travel path member 2 and the longest tip of the insertion part. It is preferable that insertion part 7 has an insertion length of 1 to three times of that of support part 8. It is more preferably 1.5 to 2 times thereof.

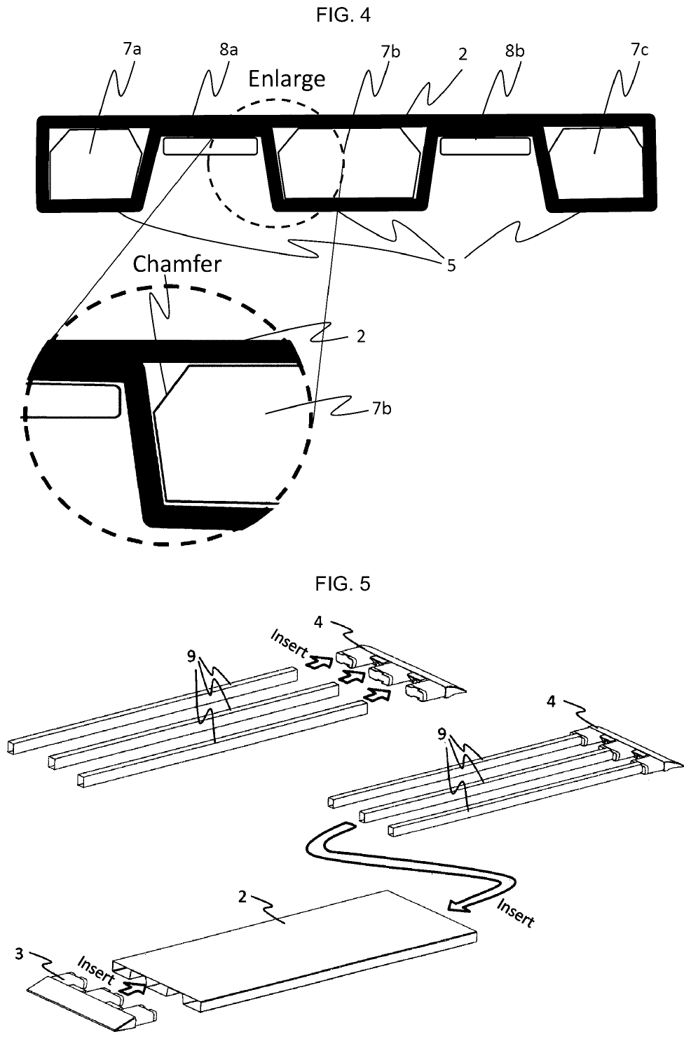

FIG. 4 shows A-A cross section view of joint between ramp travel path part 2 and end members 3 and 4. It is preferable that insertion part 7 of end members 3 and 4 to be inserted into hollow segment 5 has a chamfered shape or a rounded shape on a side of travel path member 2 so that stress concentration is relaxed. It is preferable that the chamfered shape of 5 mm or more. It is preferable that the rounded shape of 5 mm or more.

FIG. 5 shows an assembly view of reinforcing structure in which reinforcing member 9 detachably inserted into hollow part 6 of hollow segment 5 of ramp 1 comprises at least one surface contacting a surface of the hollow segment.

When ramp 1 is made longer deformation such as buckling and torsion might be caused other than a bending deformation. Even comfort might deteriorate because of increased influence of vibration. The ramp can be improved in rigidity with extended length by integrating end members 3 and 4 with reinforcing member 9 inserted into hollow segment 5 of ramp 1. Further, even local deformation can be suppressed to improve usability and comfort. To improve rigidity and strength, it is preferable that reinforcing member 9 is made of carbon fiber composite material. To suppress vibration, it is preferable that reinforcing member 9 is made of rubber material having vibration damping function. Thus, functionality can be given to ramp 1 without changing appearance of ramp 1 by employing appropriate material of reinforcing member 9.

The resin material constituting reinforcing member 9 is not limited in particular, and may be a thermosetting resin such as epoxy resin, unsaturated polyester resin, vinylester resin, phenol (resol type) resin and polyimide resin, a polyester resin such as polyethylene terephthalate (PET) resin, polybutylene terephthalate (PBT) resin, poly trimethylene terephthalate (PTT) resin, polyethylene naphthalate (PEN resin) and liquid crystalline polyester resin, a polyolefin resin such as polyethylene (PE resin), polypropylene (PP resin) and polybutylene resin, a polyoxymethylene (POM) resin, a polyamide (PA) resin, a polyarylene sulfide resin such as polyphenylene sulfide (PPS) resin, a polyketone (PK) resin, a polyether ketone (PEK) resin, a polyetheretherketone (PEEK) resin, a polyether ketone ketone (PEKK) resin, a polyether nitrile (PEN) resin, a fluorinated resin such as polytetrafluoroethylene resin, a crystalline resin such as liquid crystal polymer (LCP), a styrenic resin, an amorphous resin such as polycarbonate (PC) resin, polymethylmethacrylate (PMMA) resin, polyvinyl chloride (PVC) resin, polyphenylene ether (PPE) resin, polyimide (PI) resin, polyamide-imide (PAI) resin, polyetherimide (PEI) resin, polysulfone (PSU) resin, polyethersulfone resin and polyarylate (PAR) resin, a thermoplastic elastomer of phenol-based, phenoxy-based, polystyrene-based, polyolefin-based, polyurethane-based, polyester-based, polyamide-based, polybutadiene-based, polyisoprene-based or acrylonitrile-based, or a copolymer or modification thereof. Above all, it is preferable that the end member is made of a material structurally having a shear resistance so that buckling deformation and shear deformation of the ramp body are suppressed. From a viewpoint of weight saving, it is preferable that the end member is made of fiber-reinforced plastic. The reinforcing fiber is not limited in particular, and may be a metal fiber such as made of aluminum, brass and stainless steel, a carbon fiber of polyacrylonitrile (PAN)-based, rayon-based, lignin-based or pitch-based, a graphite fiber, an insulating fiber such as made of glass, an organic fiber such as made of aramid resin, polyphenylene sulfide resin, polyester resin, acrylic resin, nylon resin and polyethylene resin, or an inorganic fiber such as made of silicon carbide and silicon nitride, with or without surface treatment. The surface treatment may be performed with metallic conductor, coupling agent, sizing agent, binding agent or additives. The above-described reinforcing fibers can be used solely or mixed by two or more kinds. From a viewpoint of weight saving, it is preferable that the reinforcing fiber is made of carbon fiber of PAN-based, pitch-based or rayon-based, excellent in specific strength and specific rigidity. It is more preferable to employ the PAN-based carbon fiber excellent in mechanical characteristics such as strength and elastic modulus. It is possible that the reinforcing fiber is a discontinuous fiber or a continuous fiber. It is preferable that the reinforcing fiber is reinforced and oriented in two or more directions. It is preferable that the reinforcing member has an in-plane shear elastic modulus of 3,000 MPa or more.

It is preferable that the insertion part inserted into hollow segment 5 is integrated by bonding so that reinforcement is improved.

It is preferable that the insertion part inserted into hollow segment 5 is integrated by mechanically fastening so that reinforcement is improved.

### INDUSTRIAL APPLICATION

Our tools are industrially available as a traveling assistance tool used with ramp to be placed over a step between objects for wheelchairs to travel thereon.

1-6. (Canceled)

7. A traveling assistance tool for a wheelchair comprising:
a travel path member including a travel path part on which the wheelchair travels and a reinforcing part which reinforces the travel path part from below; and
an end member which is fitted to an end of the travel path member to introduce the wheelchair onto the travel path part,
the reinforcing part being formed by a plurality of hollow segments disposed along a bridging direction of the travel path part, and
the end member having an insertion part to be inserted into an end of the reinforcing part and a support part to support the end of the reinforcing part from below.

8. The traveling assistance tool according to claim 7, wherein the insertion part and the support part are disposed alternately on the end member.

9. The traveling assistance tool according to claim 7, wherein the insertion part and the support part have an extruded shape.

10. The traveling assistance tool according to claim 7, wherein the reinforcing member is positioned by an external component part provided at an end of the hollow segment.

11. The traveling assistance tool according to claim 7, wherein the insertion part has a length of 1 or more and 2 or less of that of the support member.

12. The traveling assistance tool according to claim 7, wherein the travel path member is made of a carbon fiber-reinforced plastic and the end member is made of a resin.
